(19) United States
(12) Patent Application Publication
(10) Pub. No.: US 2008/0273955 A1
(43) Pub. Date: Nov. 6, 2008

(54) REFUSE COLLECTION DEVICE AND DISPOSAL METHOD FOR PUBLIC TRANSPORTATION VEHICLES

(75) Inventor: Samuel Peguero, Monterrey (MX)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC., Warrenville, IL (US)

(21) Appl. No.: 11/743,181

(22) Filed: May 2, 2007

(51) Int. Cl. B65F 1/14; B65F 3/00; B65F 9/00

(52) U.S. Cl. 414/487; 414/469; 414/809

(57) ABSTRACT

A vehicle for receiving and storing refuse includes a passenger carrying body having an outside surface and a cavity located in the passenger carrying body. A collection device is disposed in the cavity and is accessible from the outside surface. The collection device receives and stores the refuse, and has a retracted position for receiving refuse, and an extended position for releasing refuse from the collection device.

### BACKGROUND OF THE INVENTION

The present invention relates generally to refuse collection devices, and more particularly, relates to refuse collection devices on vehicles and a method for disposing the collected refuse.

Passengers of public transportation vehicles are often required to dispose of refuse before entering the vehicle. Public transport vehicles typically do not have trash receptacles available to the public in the passenger carrying body because the refuse can take up volume needed for the passengers. Additionally, the accumulation of refuse can result in an unpleasant smell in the passenger carrying body. Further, removal of the refuse requires the driver, or some other employee, to manually remove the refuse from the passenger carrying body.

Since there is no place to dispose of refuse on the vehicle, passengers have to locate a refuse bin before entering the vehicle. Alternately, if a refuse bin is not conveniently located, passengers may litter or improperly dispose of items, such as by putting recyclable refuse into a trash bin. Since locating a refuse bin can be inconvenient, often times the disposed items end up on the streets and sidewalks, which can clog sewers and cause an unhygienic situation. Alternately, a taxpayer is potentially subjected to increased taxes for a sanitation service to pick up the disposed items.

Thus, there is a need for a refuse collection device and method for disposing the collected refuse that will discourage littering or improper disposal of refuse.

Further, there is a need for a refuse collection device on a vehicle and a method for disposing the collected refuse that does not compromise passenger comfort on the vehicle.

### BRIEF SUMMARY OF THE INVENTION

The above-listed needs are met or exceeded by the present vehicle for receiving and storing refuse, which includes a passenger carrying body having an outside surface and a cavity located in the passenger carrying body. A collection device is disposed in the cavity and is accessible from the outside surface. The collection device receives and stores the refuse, and has a retracted position for receiving refuse, and an extended position for releasing refuse from the collection device.

A refuse collection device for a vehicle having a cavity that is accessible at an outside surface of a passenger carrying body includes a bin disposed in the cavity. The bin is configured for receiving and storing the refuse and is defined by a plurality of walls. In a first position, the bin receives and stores the refuse, and in a second position, at least one wall is moved with respect to the remainder of the walls to release the refuse.

A method for collecting refuse on a vehicle and disposing the refuse from the vehicle, includes providing a collection device on the vehicle. The collection device has a bin disposed in a cavity that is accessible from an outside surface of the vehicle. The bin is configured for receiving and storing the refuse, and is defined by a plurality of walls. In a first position, the bin receives and stores the refuse, and in a second position, at least one wall is moved with respect to the remainder of the walls to release the refuse. The method also includes the step of depositing the refuse into the collection device.

### BRIEF DESCRIPTION OF THE DRAWINGS

FIG. 1A is a plan view of a vehicle having a collection device of the present invention;

FIG. 1B is a plan view of the vehicle having an alternate embodiment of collection device of the present invention;

FIG. 2 is a partial plan view of the vehicle having the collection device of FIG. 1B;

FIG. 3 is a partial perspective view of the vehicle at a collection station with the collection device automatically deployed;

FIG. 4A is a schematic side view of the collection device in a retracted position;

FIG. 4B is a schematic side view of the collection device in an extended position; and

FIG. 5 is a front plan view of the vehicle at a collection station with the collection device manually deployed.

### DETAILED DESCRIPTION OF THE INVENTION

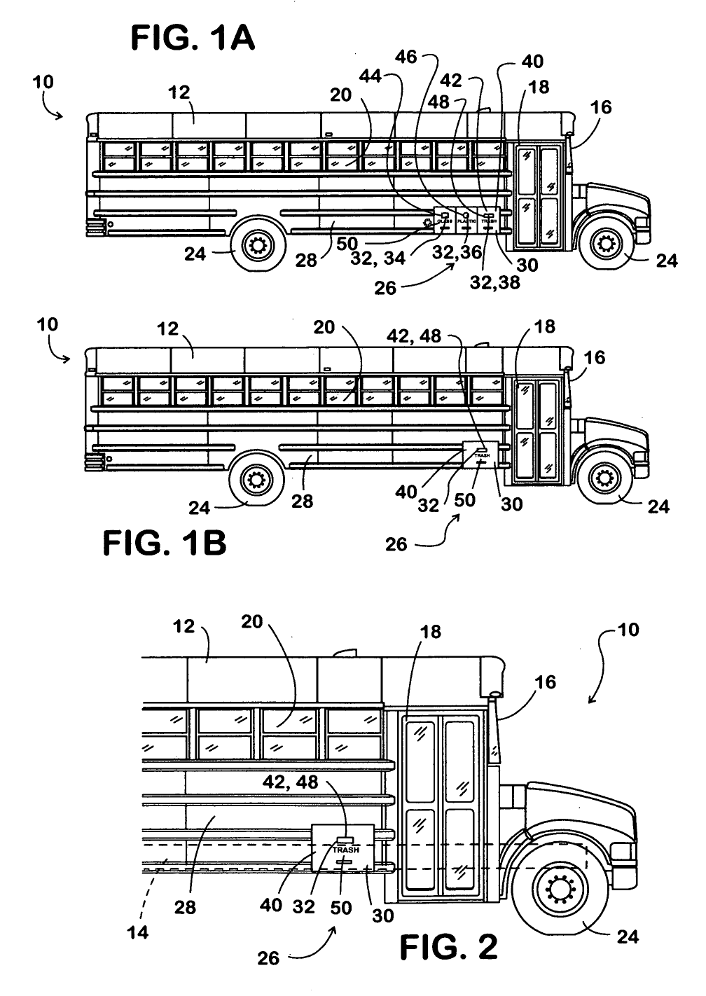

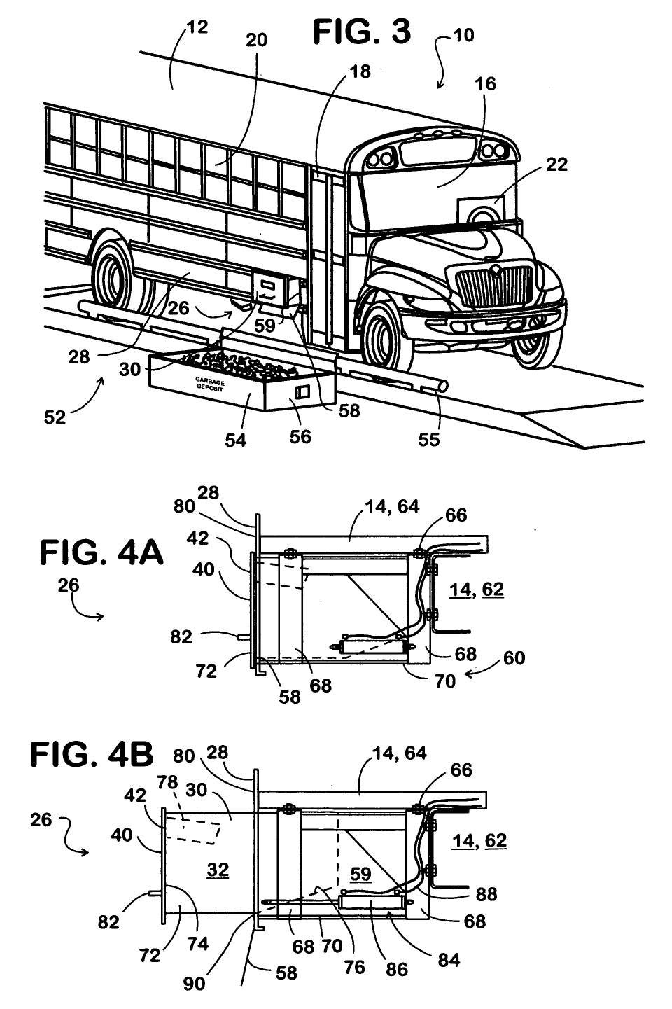

Referring to FIGS. 1-2, a bus or other motor vehicle 10 includes a passenger carrying body 12 secured to a frame 14. At the front end 16 of the passenger carrying body 12 is a door 18 for entry into the passenger carrying compartment 20, and a driver's area 22 (see FIG. 3) for the driver to operate the vehicle. Wheels 24 are attached to and support the frame 14 above the ground.

The vehicle 10 also includes a collection device, indicated generally at 26, preferably located on an outside surface 28 of the passenger carrying body 12 near the entry or exit doors 18. It is contemplated that the collection device 26 can be located at any outside surface 28 of the vehicle 10, including adjacent a door 18 located at the rear of the vehicle, or anywhere else on the vehicle.

The collection device 26 includes at least one bin 30 attached to the frame 14 for collecting and temporarily storing refuse. Preferably, the bin 30 is divided into a plurality of receptacles 32 for sortably receiving different types of refuse, for example, a glass receptacle 34 for receiving glass, a plastic receptacle 36 for receiving plastic, and a trash receptacle 38 for receiving non-recyclable trash. Alternately, as seen in FIG. 1B, the collection device 26 can be a bin 30 having a single receptacle 32.

The collection device 26 preferably has a front face 40 with an opening 42 to the receptacle 32. The opening 42 can have any configuration that permits introduction of refuse into the receptacle 32. In the preferred embodiment, the opening 42 is shaped according to the type of refuse the receptacle 32 is intended to receive, such as a square opening 44 for glass, a circular opening 46 for plastic, and a rectangular opening 48 for trash. Additionally, the front face 40 can have an indicator 50, such as wording or symbols that indicate the type of refuse that goes into each receptacle 32.

By providing a collection device 26 on the vehicle 10 adjacent to the door 18, where the collection device is easily accessible, it discourages potential littering or improper disposal of refuse from passengers about to enter the vehicle. Further, since the collection device 26 is separated from the passenger compartment 20, the device does not compromise passenger comfort. When the collection device 26 is filled with refuse, or on a regular basis, the vehicle 10 releases the contents of the collection device.

Referring now to FIG. 3, the vehicle 10 preferably drives to a collection station, indicated generally at 52, having a refuse depository 54. In the preferred embodiment, the driver drives the vehicle 10 to the collection station 52 and aligns the collection device 26 and the refuse depository 54. A rail guard 55 can be used to prevent the vehicle 10 from driving too close to the refuse depository 54, and additionally, can be used as a tool for the driver to properly align the vehicle 10. Further, it is contemplated that other indicators may be used to aid the driver in positioning the vehicle 10. Alternately, the refuse depository 54 can be movable.

The bin 30 preferably has a “drawer”-like configuration, and when the vehicle 10 is aligned, the driver activates the bin to extend outward and away from the outside surface 28 of the vehicle. When the bin 30 is extended, a bottom lid 58 of the bin swings opens to release the contents of the bin into the refuse depository 54. The refuse depository, indicated generally at 54, is preferably a large container 56 used to temporarily store refuse. Additionally, the refuse depository 54 may include a trash compactor or grinder, or any other machinery used to treat the refuse.

It is contemplated that a sanitation service could collect the refuse from the refuse depository 54, either on a regular basis or as needed, to take the refuse to the landfill, the recycling plant or anywhere else. In the preferred method, the sanitation service takes the container 56 and replaces it with a new, clean container. Alternately, the sanitation service empties the existing container 56.

For use with a vehicle 10 having a collection device with multiple receptacles 32, it is contemplated that the container 56 could be divided into corresponding sections (not shown). For example, the container for use with the vehicle 10 of FIG. 1A would preferably be divided into three sections, a first section for glass, a second section for plastic, and a third section for trash. Then, when the vehicle 10 aligned itself with the refuse depository 54, the collected glass would be received into the first section of the container 56, the plastic would be received into the second section of the container, and the trash would be received in the third section of the container.

As seen in FIGS. 3-4B, the bin 30 is preferably automatically activated by the driver with an input device (not shown) located in the driver's area 22. A description of the preferred embodiment of the automatically actuated collection device 26 will be described below.

The collection device 26 is preferably mounted in a cavity 59 of the passenger carrying body 12 of the vehicle 10. A bin frame 60 is attached to the frame 14 of the vehicle 10, preferably at a chassis frame 62 and at a body frame 64, with at least one fastener 66. The bin frame 60 includes at least one vertical member 68 and at least one horizontal member 70 attached to the vehicle frame 14 to supportably receive a drawer portion 72.

The drawer portion 72 is slidably mounted within the bin frame 60. Inside surfaces 74 of the drawer portion 72 define the receptacle 32 for receiving and storing refuse. The drawer portion 72 is generally box-shaped with a sloped back wall 76, however any configuration of drawer portion is contemplated. The front face 40 of the drawer portion 72 includes the opening 42, and a chute 78 can be attached to the opening to position the refuse towards the back wall 76 of the drawer portion.

In FIG. 4A, the bin 30 is in a retracted position with the front face 40 of the drawer portion 72 generally flush with or slightly relieved from an exterior body panel 80. The front face 40 may include a handle 82 for manually pulling the drawer portion 72 open.

In FIG. 4B, the bin 30 is in an extended position with the front face 40 of the drawer portion 72 positioned away from the exterior body panel 80. The drawer portion 72 is extended and retracted with an actuator 84 that is disposed in the cavity 59, and is preferably attached to either the chassis frame 62 or the bin frame 60. The actuator 84 is preferably a pneumatic cylinder 86, however other actuators may be used. Air pressure lines 88 are attached to the cylinder 86 to actuate the actuator 84 when the driver uses the input device (not shown).

The bottom lid 58 is preferably pivotably connected to the drawer portion 72 at a pivot point 90. When the drawer portion 72 is retracted, the bottom lid 58 is prevented from pivoting by the bin frame 60 and or the exterior body panel 80. However, when the drawer portion 72 is extended, the bottom lid 58 pivots open to release the stored refuse. In the preferred embodiment, the bottom lid 58 is configured to pivot less than 90-degrees so that the refuse can slide down the lid into the refuse depository 54.

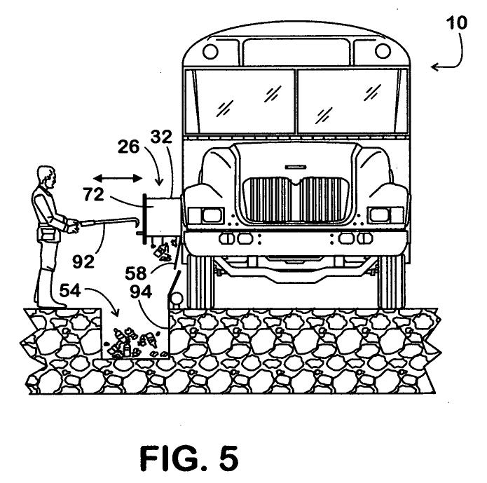

In FIG. 5, a non-automatic or manual collection device 26 is shown. The manual collection device 26 and method of using is generally similar to the automatic collection device, except the manual collection device does not require an actuator 84. Instead, the drawer portion 72 is extended and retracted by a user manually pulling and pushing on the drawer portion. As seen in FIG. 5, a user may use a pulling device 92 that hooks into the handle 82 on the front face 40.

A second embodiment of refuse depository 54 is also shown in FIG. 5. Instead of a container 56, the refuse depository 54 is a channel 94 in the ground.

For both embodiments, the drawer portion 72 is extended and retracted, and the refuse is released from the collection device 26, with minimal mechanical parts. Additionally, the drawer portion 72 can be easily cleaned when it is in the extended position. It is contemplated that a water nozzle (not shown) can be located in the drawer portion 72 to periodically clean the receptacle 32.

It is also contemplated that other configurations other than a drawer-like collecting device 26 can be used. For example, the bin 30 may be sloped towards the front face 40, and the front face may be removed from the bin to release the refuse. As another example, the bottom lid 58 may be stationary with respect to the bin frame 60, and the remainder of the drawer portion 72 may extend, letting the refuse drop from the drawer portion. Additionally, it is contemplated that the collection device 26 includes discrete bins 30 that are actuated separately from each other.

While particular embodiments of the present refuse collection device and method of disposing refuse have been shown and described, it will be appreciated by those skilled in the art that changes and modifications may be made thereto without departing from the invention in its broader aspects and as set forth in the following claims.

1. A vehicle for receiving and storing refuse, comprising:
a passenger carrying body having an outside surface;
a cavity located in said passenger carrying body;
a collection device disposed in said cavity and accessible from said outside surface, said collection device configured for receiving and storing refuse, said collection device having a retracted position for receiving refuse, and an extended position for releasing refuse from said collection device.

2. The vehicle of claim 1 wherein said collection device is located adjacent a door of the vehicle.

3. The vehicle of claim 1 wherein said collection device includes at least one bin having a drawer portion slidably received in said cavity.

4. The vehicle of claim 3 wherein said collection device has a front face with an opening to the interior of said bin.

5. The vehicle of claim 3 wherein said at least one bin further comprises a bottom lid pivotably connected to said bin at a pivot point.

6. The vehicle of claim 5 wherein said bottom lid is configured to pivot when said collection device is in said extended position.

7. The vehicle of claim 3 wherein said at least one bin further comprises a bin frame having at least one vertical member and at least one horizontal member for supportably receiving said drawer portion.

8. The vehicle of claim 1 wherein said collection device is extended and retracted with respect to the vehicle by an actuator disposed in said cavity.

9. The vehicle of claim 8 wherein said collection device is automatically activated by a user from inside the vehicle.

10. A refuse collection device for a vehicle having a cavity accessible at an outside surface of a passenger carrying body, comprising:
a bin disposed in the cavity and accessible from the outside surface, said bin configured for receiving and storing refuse, said bin defined by a plurality of walls, wherein in a first position, said bin receives and stores the refuse, and in a second position, at least one wall is moved with respect to the remainder of said walls to release the refuse.

11. The collection device of claim 10 wherein said bin includes a drawer portion slidably received in the cavity.

12. The collection device of claim 11 wherein said drawer portion comprises a bottom lid that is pivotably attached to said drawer portion.

13. The collection device of claim 10 wherein said bin has a front face with an opening to the interior of said bin.

14. The collection device of claim 10 wherein said bin is extended and retracted with respect to the vehicle by an actuator disposed in the cavity.

15. The collection device of claim 14 wherein said bin is automatically activated by a user from inside the vehicle.

16. The collection device of claim 14 wherein said bin is manually extended and retracted.

17. A method of collecting refuse on a vehicle and disposing refuse from the vehicle, comprising:
providing a collection device on the vehicle, wherein the collection device has a bin disposed in a cavity that is accessible from an outside surface of the vehicle, said bin configured for receiving and storing refuse, said bin defined by a plurality of walls, wherein in a first position, said bin receives and stores the refuse, and in a second position, at least one wall is moved with respect to the remainder of said walls to release the refuse; and
depositing refuse into said collection device.

18. The method of claim 17 further comprising the steps of delivering said refuse to a collection station having a refuse depository, aligning said collection device and said refuse depository, and releasing the refuse from said collection device to said refuse depository.

19. The method of claim 17 further comprising providing said collection device with an actuator to automatically release the refuse from said bin.

20. The method of claim 17 wherein said collection device is disposed on the vehicle near a door.
